(19) United States
(12) Patent Application Publication
(10) Pub. No.: US 2011/0246926 A1
(43) Pub. Date: Oct. 6, 2011

(54) COMPARATIVE ACTION MANAGEMENT

(75) Inventor: Mark Asbury Newton, Atlanta, GA (US)

(73) Assignee: IRUNURUN, LLC, Atlanta, GA (US)

(21) Appl. No.: 13/077,590

(22) Filed: Mar. 31, 2011

Related U.S. Application Data
(60) Provisional application No. 61/320,488, filed on Apr. 2, 2010.
(60) Provisional application No. 61/438,967, filed on Feb. 2, 2011.

(51) Int. Cl. G06F 15/16; G06F 3/048

(52) U.S. Cl. 715/772; 709/219

(57) ABSTRACT

Systems, methods, and computer-readable media are provided for enabling a user to set action items and automatically track the action items for the user. One implementation includes a server in communication with a network. The server according to some embodiments comprises a processing device configured to execute logic instructions of the server. The server also includes an interface device configured to communicate with an end user device via the network. An objective definition module is configured to enable a user of the end user device to enter at least one action item intended to be performed by the user during a specific time period. A recordation module is configured to receive updates from the user regarding a successful completion of at least a portion of the at least one action item. The recordation module is further configured to calculate progress that the user has made toward completing each of the at least one action item.

### CROSS-REFERENCE TO RELATED APPLICATIONS

This application claims priority to U.S. Provisional Application No. 61/320,488, filed Apr. 2, 2010, and to U.S. Provisional Application No. 61/438,967, filed Feb. 2, 2011, the entire disclosures of which are hereby incorporated by reference herein.

### TECHNICAL FIELD

The present disclosure generally relates to action management, and more particularly relates to automatically tracking and reporting the progress made toward performing set objectives.

### BACKGROUND

Many self-improvement methods and systems exist to meet a natural desire to improve one's health, financial situation, spiritual well-being, and other areas of life. A first step toward self-improvement often involves defining a goal for a person. A second step often occurs when people attempting to achieve similar goals form groups (e.g., weight loss groups). In this way, the group can provide accountability to each other and encourage one another to overcome the inevitable challenges that are faced when attempting to reach their goals.

However, there are a variety of shortcomings to traditional accountability groups. Among other problems, the broad scopes of goals often make the goals seem too large for the individuals to achieve. Individuals may become easily side-tracked with other less important issues and never meet their goals. Also, when goals are the measure of accountability in a group, the group often cannot effectively provide competitive incentive for its members to meet the goal, as the broad goal is the only means of measurement for the members of the group.

### SUMMARY

The present disclosure describes systems, methods, and computer-readable media for managing action items and objectives for one or more individuals. In some implementations, a server is provided in communication with a network. The server includes a processing device configured to execute logic instructions of the server and an interface device configured to communicate with an end user device via the network. The server also includes an objective definition module, which is configured to enable input of one or more action items intended to be performed by the user during a specific time period. A calculation module is provided to receive updates regarding a successful completion of at least a portion of the one or more action items and to calculate progress that the user has made toward completing each of the one or more action items.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a block diagram illustrating a system for managing action items, according to various implementations of the present disclosure.

FIG. 2 is a block diagram illustrating the server shown in FIG. 1, according to various implementations of the present disclosure.

FIG. 3 is a block diagram illustrating a program for managing action items, according to various implementations of the present disclosure.

FIGS. 4A through 4C, collectively, are a flow diagram illustrating a method of automatically managing action items, according to various implementations of the present disclosure.

FIG. 5 is a flow diagram illustrating a method of enabling a user to set action items, according to various implementations of the present disclosure.

FIG. 6 is a diagram illustrating a first graphical user interface (GUI) for enabling a user to login to the system for managing action items, according to various implementations of the present disclosure.

FIG. 7 is a diagram illustrating a second GUI for enabling a user to login to the system for managing action items, according to various implementations of the present disclosure.

FIG. 8 is a diagram illustrating the GUI of FIG. 7 with a pop up window, according to various implementations of the present disclosure.

FIG. 9 is a diagram illustrating a GUI for enabling a user to enter user settings, according to various implementations of the present disclosure.

FIG. 10 is a diagram illustrating a first GUI dashboard for enabling a user to enter action items, according to various implementations of the present disclosure.

FIG. 11 is a diagram illustrating a second GUI dashboard for enabling a user to record progress, according to various implementations of the present disclosure.

FIG. 12 is a diagram illustrating the second GUI dashboard of FIG. 11 with a quantity window opened, according to various implementations of the present disclosure.

FIG. 13 is a diagram illustrating a GUI for enabling an administrator to manage action items for individuals and teams, according to various implementations of the present disclosure.

FIG. 14 is a diagram illustrating a GUI for enabling an administrator to manage the settings for teams, according to various implementations of the present disclosure.

FIG. 15 is a diagram illustrating a GUI for enabling an administrator to adjust color settings, according to various implementations of the present disclosure.

FIG. 16 is a diagram illustrating an example of a first automatic email sent to a user of the system for managing action items of FIG. 1, according to various implementations of the present disclosure.

FIG. 17 is a diagram illustrating an example of a reply to the first automatic email of FIG. 16, according to various implementations of the present disclosure.

FIG. 18 is a diagram illustrating an example of a second automatic email notifying a user of the system for managing action items of FIG. 1 of progress scores, according to various implementations of the present disclosure.

FIG. 19 is a diagram illustrating an example of an invitation message allowing the user to invite additional members of a team, according to various implementations of the present disclosure.

### DETAILED DESCRIPTION

The present disclosure describes systems, methods and computer-readable media for enabling a person or a group of people to set personal objectives defined by measurable action items. The systems and methods herein use techniques that encourage the users to continue striving to meet their objectives. For example, having accountability with others is a good strategy for staying focused and completing action items. The implementations described in the present disclosure allow members to form teams that may provide this accountability. To help a person stay focused on his or her objectives, the systems and methods herein are configured to send daily reminders to the user to help the user get into good habits of recording progress being made toward the person's action items. In some embodiments, the systems and methods may be associated with a web server that allows the user easily to enter daily progress. The user's results are tallied and displayed in a motivating manner that is easy to read and understand.

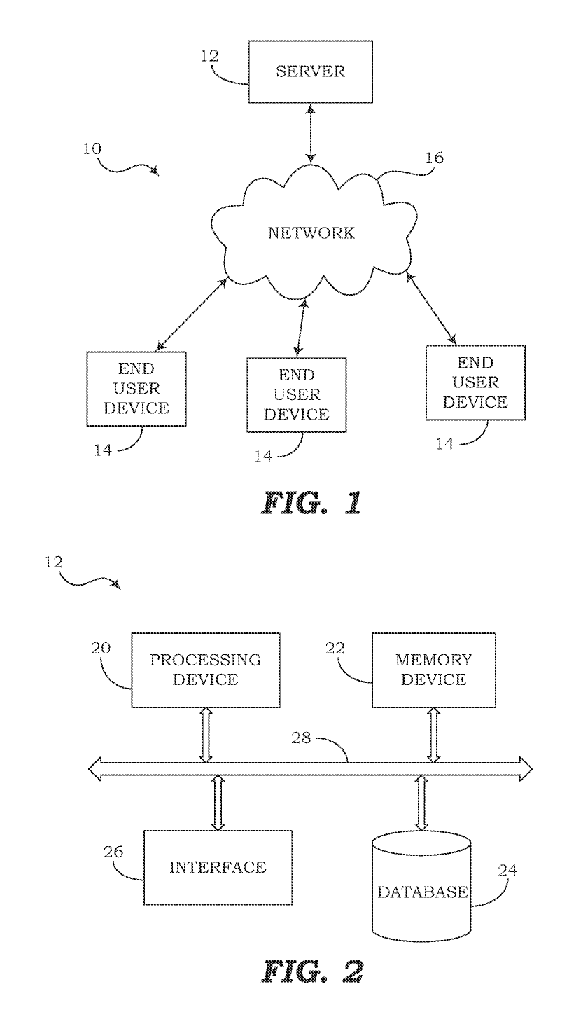

FIG. 1 is a block diagram illustrating an embodiment of a system for managing action items 10 in accordance with various implementations of the present disclosure. In this embodiment, the system for managing action items 10 includes a server 12 which communicates with one or more end user devices 14 via a network 16. The server 12 may be implemented as a web server, e-mail server, logic of a handheld device, logic of a personal computer, or any suitable combination of these or other servers. The server may also be simulated from computer-readable media, such as read-only memory (ROM), flash memory, random access memory (RAM), and other forms of computer-readable media. The end user devices 14 may include personal computers, wireless computers, mobile devices (e.g., mobile phones, smart phones, personal digital assistants (PDAs), etc.), or other devices capable of communicating with other devices on a network and providing user interfaces for communicating with the user of the device. The network 16 may be a data network, telephone network, wireless network, Bluetooth network, local area network (LAN), wide area network (WAN), the Internet, or any combination of these or other networks allowing communication among a number of devices. The network 16 may include components designed for wired and/or wireless communication.

In some embodiments, the end user devices 14 may include a modem or other interface device for accessing resources via the network 16. The server 12 may be configured to provide resources (e.g., web pages) to the end user devices 14. The server 12 may provide graphical user interfaces (GUIs) that are configured to display information to the users and receive input from the users. In other embodiments, graphical user interfaces may be provided by the end user device 14, such as an application on a PDA, smart phone, or personal computer. According to various implementations of the present disclosure, the server 12 is configured to enable the users to enter and/or edit measurable objectives defined by various action items to meet the objectives as desired. For example, a user may wish to define action items for the purpose of meeting at least one self improvement objective in one or more areas that are important to the user. In some embodiments, an enterprise may define action items for employees, clients, customers, or subscribers in a team, among other uses.

When action items are defined, the server 12 enables the user to record (e.g., on a daily basis) any progress that has been made toward completing an action item and meeting an objective. The server 12 may also remind or prompt the user, such as by e-mail messages, to enter his or her progress. When updates are made to indicate completion of an action item or a portion of such item, the server 12 is configured to calculate the percentages of completion. From this calculation, the server 12 may determine a total score (e.g., 0 to 100) for display on the end user device 14. Although this calculation is performed by a server in the preferred embodiment, other embodiments could include multiple server analysis, calculation by the end user device 14, or other methods of calculation.

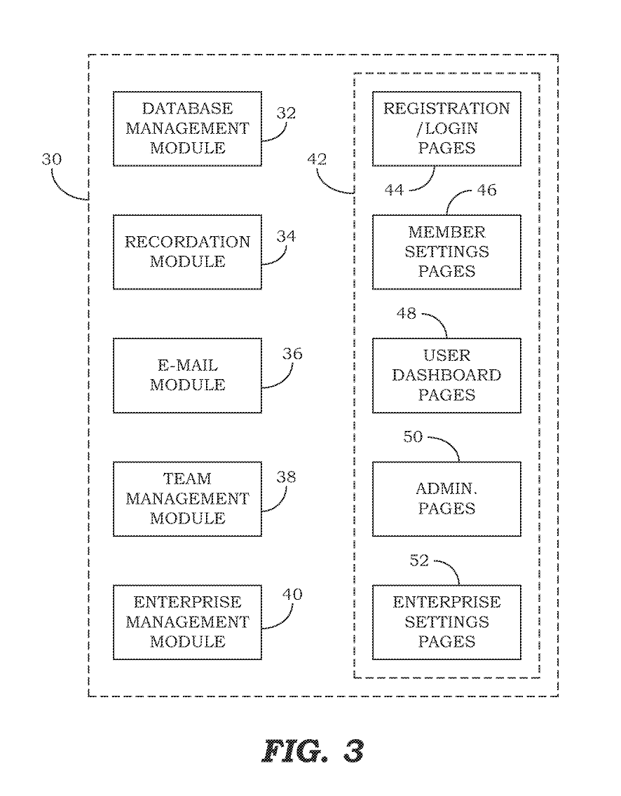

FIG. 2 is a block diagram illustrating an embodiment of the server 12 shown in FIG. 1, according to various implementations. In the embodiment of FIG. 2, the server 12 comprises a processing device 20, a memory device 22, a database 24, and an interface 26. As illustrated, the elements may communicate with each other via a bus 28. In some embodiments, the processing device 20 may include a plurality of processing devices, the memory device 22 may include a plurality of memory devices, the database 24 may include a plurality of databases, and/or the interface 26 may include a plurality of interfaces. For example, the database 24 may include a first database for storing usernames and passwords, a second database for storing user information and profile photos, a third database for storing action items, a fourth database for storing weekly progress, a fifth database for storing results over multiple time periods, or other combinations of multiple databases. Use of the term “user information” is not intended to connote any specific information about the user and could include any information specific to the particular user, including name, address, email address, phone numbers, member numbers, employee numbers, and participant numbers, among other possibilities. In some embodiments, all or parts of the database 24 may be housed with the other elements of the server 12. According to some implementations, the database 24 may be remote from the server 12 and accessed as needed. When housed within the server 12, all or part of the database 24 may be contained within the memory device 22, according to some embodiments.

The processing device 20 may be a general-purpose or specific-purpose processor or microcontroller for controlling the operations and functions of the server 12. In some implementations, the processing device 20 may include a plurality of processors for performing different functions within the server 12 according to various designs.

The memory device 22 may include one or more internally fixed storage units, removable storage units, and/or remotely accessible storage units, each including a tangible storage medium. The various storage units may include any combination of volatile memory and non-volatile memory. For example, volatile memory may comprise random access memory (RAM), dynamic RAM (DRAM), etc. Non-volatile memory may comprise read only memory (ROM), electrically erasable programmable ROM (EEPROM), flash memory, hard drives, etc. The storage units may be configured to store any combination of information, data, instructions, software code, etc.

FIG. 3 is a block diagram illustrating one embodiment of a program for managing action items 30. The program for managing action items 30 may include any combination of software, firmware, and/or hardware and may be stored at least in part in the memory device 22 and/or configured in the processing device 20. According to this embodiment, the program for managing action items 30 includes a database management module 32, a recordation module 34, an e-mail module 36, a team management module 38, an enterprise management module 40, and an objective definition module 42. As illustrated, the objective definition module 42 includes registration/login pages 44, member settings pages 46, user dashboard pages 48, administrator pages 50, and enterprise settings pages 52. It should be noted that combinations of these pages could be possible in any combination of pages. For example, a single page that includes user dashboard pages 48 and enterprise settings pages 52 may be possible. Furthermore, one or more modules may be combined, expanded, or excluded in some embodiments since the modules represent one or more functions that may be performed by various programming implementations. It should also be understood that pages may be statically and/or dynamically generated in accordance with the functions defined below. In addition, some embodiments include data communications that are formatted in other formats that are not characterized as pages, but nonetheless provide at least a portion of the functions discussed herein.

The database management module 32 is configured to manage the data and information to be recorded in the database 24 and to retrieve the data and information from the database 24 as needed. For example, the database management module 32 may be configured to store at least a portion of the following: usernames, passwords, user information and settings, profile photos, user action items, updated weekly progress, user results over multiple time periods, and/or other data or information regarding the process of tracking action items.

The recordation module 34 is configured to receive updates from the users for indicating completion of action items and/or portions of the objectives. The updates may include an indication of a single action for a particular day or a quantity. The portions completed are added to the stored totals completed for a certain time period (e.g., one week). The totals are divided by a quantitative measure of the action item for that time period to determine an updated percentage of completion.

The e-mail module 36 enables the members of a team (e.g., a group of people who have similar or differing action items) to send e-mails to each other. Team member scores can be attached to promote competition among the team. In addition, the e-mail module 36 is configured to send automatic e-mails to the users to remind them to enter their updates. In some embodiments, the automatic e-mails may include the user's specific action items and the percentages that have already been completed for the time period. In response to the automatic e-mails, the user may enter a recognized entry for indicating whether action items have been completed or not or how much of an action item has been completed. In response to the e-mails, the user may choose to access the server through embedded hyperlinks using the end user device 14 to enter updates. Other embodiments include other types of communication with users, including instant messaging and communication methods other than email messages.

The team management module 38 is configured to enable a user to invite and/or be invited by other users. The team management module 38 allows an invited guest to accept or reject an invitation to join a team. In some embodiments, the user may join any number of teams. When a user is part of a team, the scores of each of the team members are displayed on the user's GUI dashboard, as discussed in more detail below. The team management module 38 may be configured to control how the other members and their respective scores are listed, if at all in some embodiments. In some implementations, the members may be listed in an order based on the highest scores or other ordering methods. From the dashboard, the user may also select one of the other members to see the action items and objectives that, in one embodiment, the other user has designated as public.

The enterprise management module 40 is configured to enable an administrator to oversee various aspects of the action items set for a group of people, such as a group of employees in a company or a department of a company, and/or clients, customers, or subscribers outside the company. Thus, the enterprise management module 40 may not exist in some versions used by consumers. The enterprise management module 40 enables the administrator to enter certain settings for the team or delegate that responsibility to each of the members of the team. The enterprise management module 40 may also be configured to enable the administrator to set objectives or action items for the team and/or for individual members. Some implementations also include the administrator being enabled to select whether all or selected team members are enabled to invite other users to join a team. In some embodiments, the administrator may be responsible for managing multiple teams and/or one or more levels of sub-teams. As an example, a company may include several levels of a hierarchy. One administrator may be given responsibility for some departments while one or more other administrators may be given responsibility for other departments. In some embodiments, the administrator may be excluded from the team, such as in the case where the administrator is a manager who has different responsibility than his or her subordinates. The enterprise management module 40 is further configured to enable an administrator to upload a logo (e.g., a company logo) or other image and/or customize display characteristics (e.g., color, font, style, etc.).

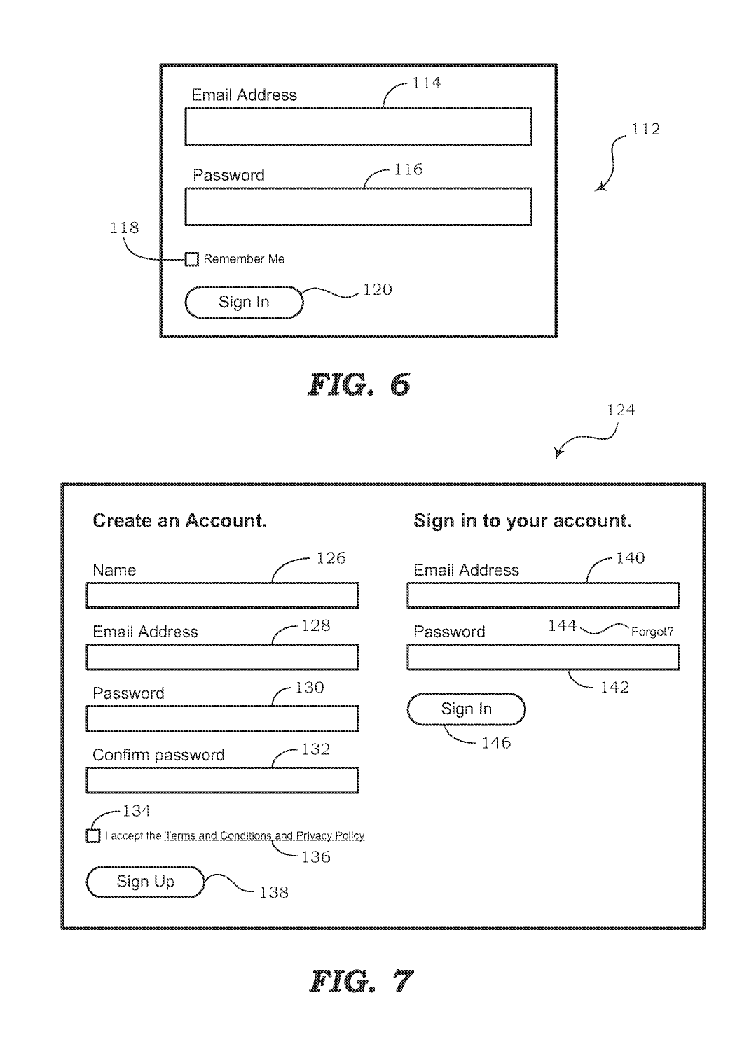

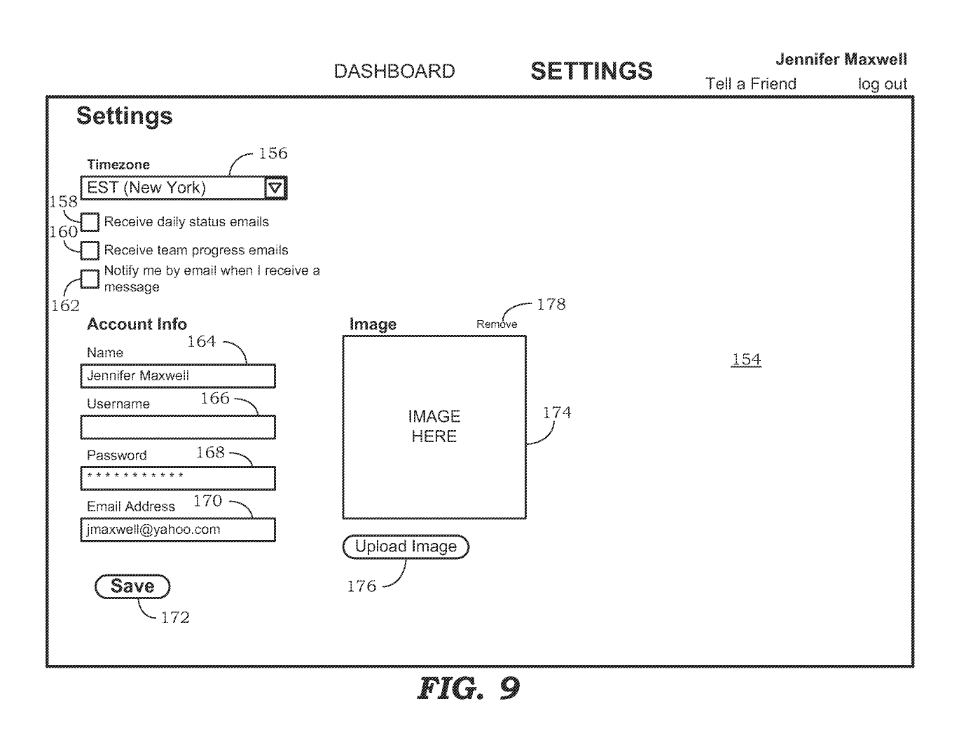

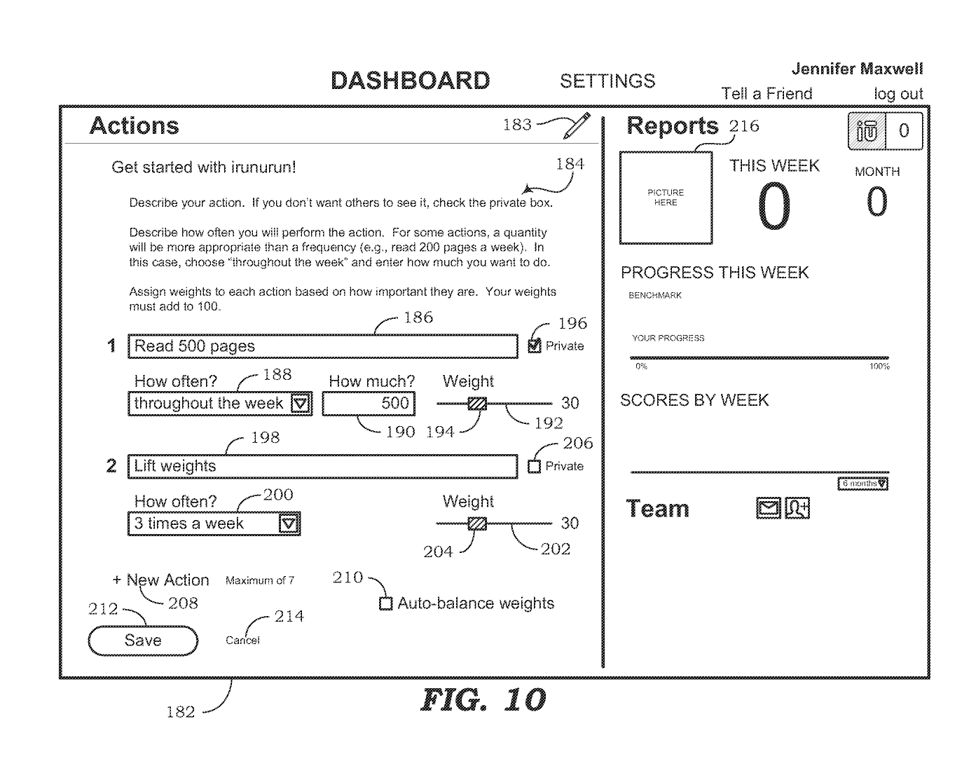

The objective definition module 42 may contain various pages (static and dynamic web pages, as well as other types of communications of information, according to various embodiments) for displaying information to the users in an appropriate manner and allowing the users to enter input information. The registration/login pages 44 (e.g., FIGS. 6-8) enable new users to register with the server 12 and enter usernames and passwords. These pages also enable the users to login to the system when an acceptable password is entered. The member settings pages 46 (e.g., FIG. 9) enable the members to enter user information and/or preferences. The user dashboard pages 48 (e.g., FIGS. 10-12) are configured to enable the user to enter action items and various aspects of those action items. The user dashboard pages 48 also provide reports of the user's progress and the progress of other team members for the given time period. The reports help the users monitor their progress.

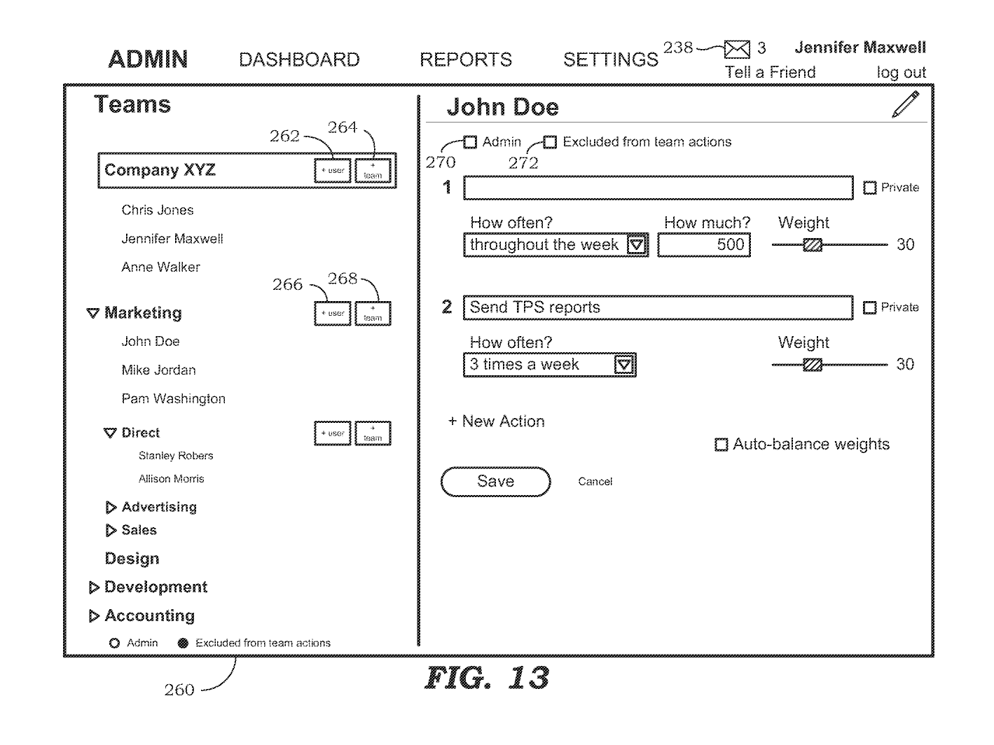

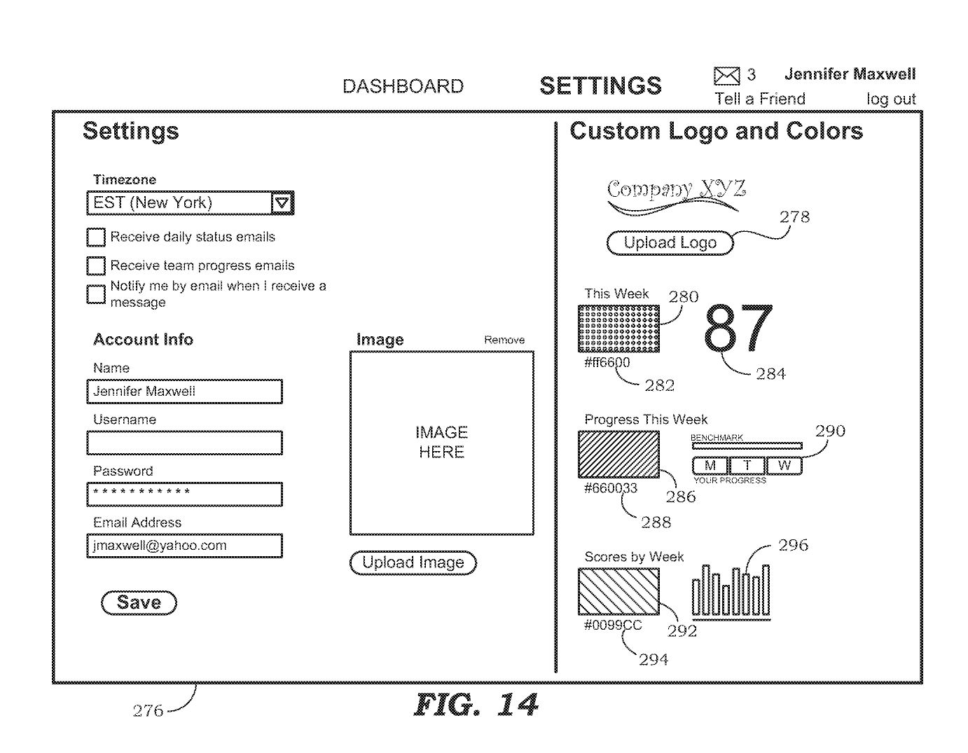

The administrator pages 50 (e.g., FIG. 13) enable one or more administrators to, among other functions that should be clear based on this disclosure, create a hierarchical structure representing a hierarchy of the enterprise. The hierarchical structure may include certain action items for certain teams, sub-teams, individuals, or any other group of people. The enterprise settings pages 52 (e.g., FIGS. 14 and 15) are configured to enable an administrator to enter information about one or more members of one or more teams. The administrator is also enabled to customize various display characteristics of the GUIs using the enterprise settings pages 52.

The program for managing action items 30 of FIG. 3 and any logical instructions, commands, and/or software code disclosed herein may be implemented in hardware, software, firmware, or any combinations thereof. The program for managing action items 30 may be stored on the memory device 22, for example. The functions of the modules are provided through execution of interpretation of suitable instructions, such as through processing device 20. According to some other embodiments, the modules may be implemented in hardware using discrete logic circuitry, an application specific integrated circuit (ASIC), a programmable gate array (PGA), a field programmable gate array (FPGA), or any combinations thereof, or through other implementations.

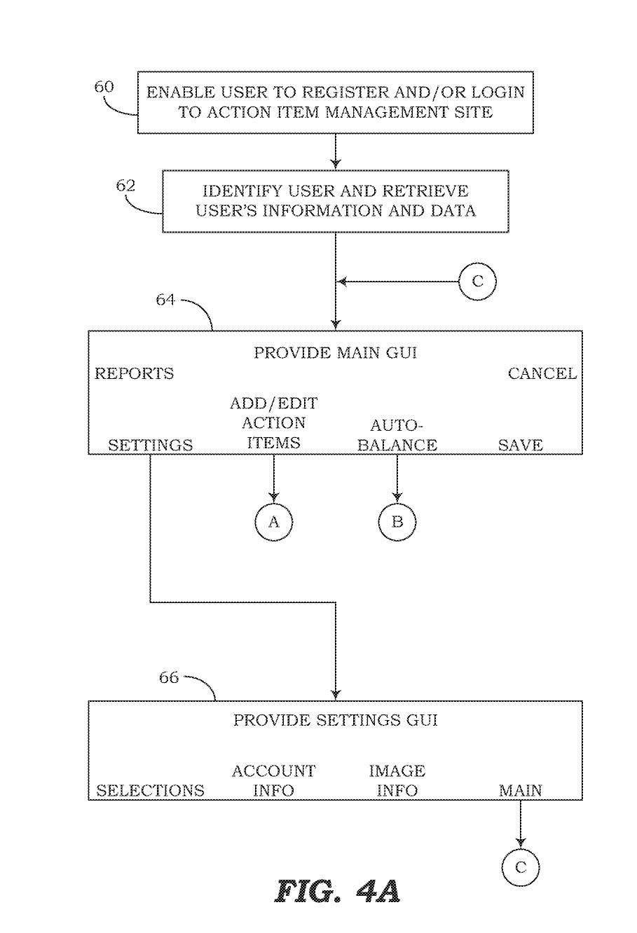

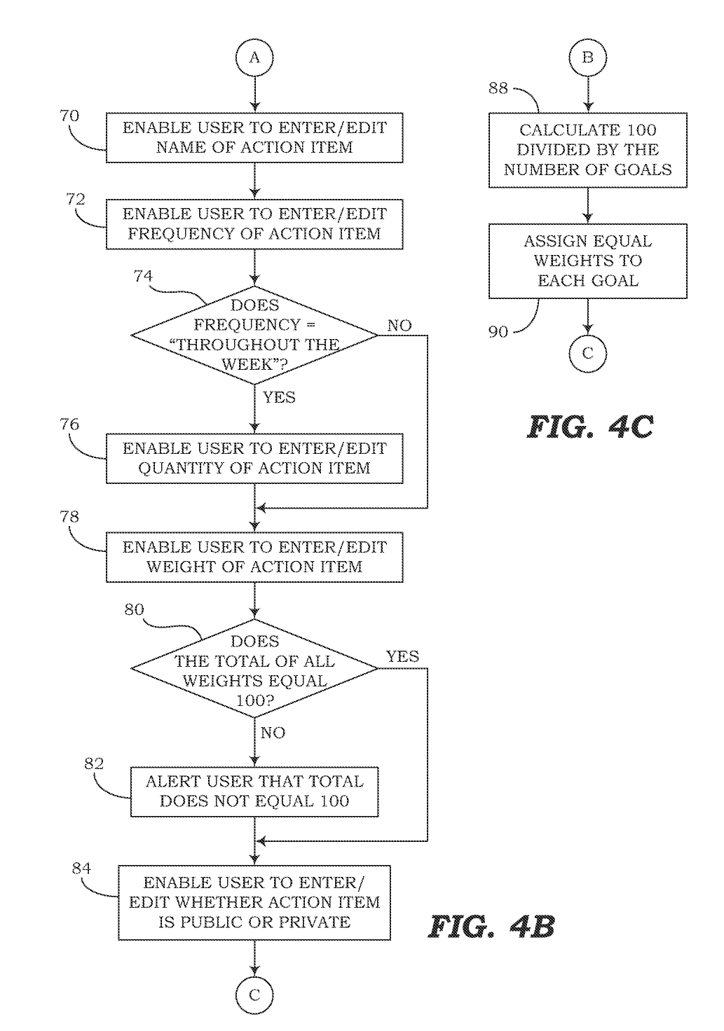

FIGS. 4A through 4C together form a flow diagram illustrating an embodiment of a method for adding and/or editing action items. In some embodiments, the flow diagram of FIG. 4 may represent various functions of the server 12 of the system for managing action items 10 of FIG. 1. As illustrated, the method includes enabling a user to register (if not already registered) and login to an action item management site, as indicated in block (or step) 60. The action item management site may be a web site associated with various web pages for managing individual and team action items. When a user has logged in, the user is identified and the user's information and data are retrieved, as indicated in block 62. The information and data may be retrieved, for example, from the database 24.

As shown in block 64, a main GUI page is provided to the user's device (e.g., end user device 14). The main GUI provides information (e.g., displayed information, or “reports”) to the user and also allows the user to perform many different actions. According to various embodiments, the main GUI may allow the user to navigate to another page to enter the user's “settings.” To return from a settings page, the user may navigate back to the main GUI page. The main GUI presents any action items that have already been set, if any, and allows the user to “add/edit action items” as desired. The main GUI also allows the user to request an “auto-balance” operation to equalize the weighting factor for each action item, a “save” operation to save changes to the action items, and a “cancel” operation to cancel any changes made to the action items. Some embodiments do not include an auto-balance feature.

If the user wishes to view and/or modify the settings, the user selects “settings” and the method proceeds to block 66, which indicates that a settings GUI is provided to the user. The settings GUI allows the user to view/edit “selections,” “account info,” “image info,” or return to the “main” GUI. The “selections” segment may include enabling a user to select a timezone, whether the user wishes to receive daily status emails, whether the user wishes to receive team progress emails, whether the user wishes to be notified by email when a message is received, and/or other selections available to the user. The user may also wish to view/ edit “account info,” which may include name, username, password, email address, or other information about the user's account. The settings GUI also includes an “image info” selection, which allows a user to upload or replace an image, such as a photograph of the user, which may be displayed on some of the web pages. The user may also select “main,” which returns the user back to the main GUI page.

From the main GUI (block 64), if the user wishes to enter a new action item or edit a previously entered action item, the user may select “add/edit action item” (or some other selectable icon or text) from the main GUI, and the method proceeds to block 70 (FIG. 4B). In some embodiments, a template may open to enable the user to add a new action item or to edit one or more specific action items. As indicated in block 70, the user is enabled to enter or edit a name of an action item. For example, if the user wishes to set an action item to read 500 pages of a book per week, the user may enter “Read 500 pages” or some other title. According to block 72, the user is enabled to enter or edit a frequency indicating how often the user intends to perform the action item throughout a specific time period (e.g., one week). In one embodiment, the specific time period is defined and cannot be changed, but other embodiments include adjustable time periods.

As indicated in decision block 74, it is determined whether a frequency entered or edited in block 72 indicates an action item intended to be performed “throughout the week” (or other time period). If the frequency is “throughout the week,” the method proceeds to block 76. Otherwise, block 76 is skipped. In some embodiments, when “throughout the week” is selected, a pop-up window or other prompt is displayed requesting the user to enter a “how much” quantity into a field. As indicated in block 76, the user is enabled to enter or edit the quantity of the action item (e.g., “500” for the 500 pages to be read). In some embodiments, other drop-down options in addition to “throughout the week” include “1 time per week,” “2 times per week,” “3 times per week”, “4 times per week”, “5 times per week”, “6 times per week”, and “7 times per week.” In those embodiments, selection of any option other than “throughout the week” would result in block 76 being skipped. Other frequency options are also included in other embodiments. When a time period other than one week is selected, according to some embodiments, other terminology may be used accordingly, such as “throughout the bi-week,” “throughout the month,” “1 time per bi-week,” “2 times per bi-week,” “5 times per month,” etc.

As indicated in block 78, the user is enabled to enter or edit a weighting factor for assigning a weight to the action item as a percentage of all the user's action items to define the importance of that action item with respect to the others. As indicated in decision block 80, it is determined whether the total of all weights for the action items equals one-hundred (100). If not, the method proceeds to block 82, and the system alerts the user that the total does not equal one-hundred (100). In some embodiments, the method may further include automatically providing weights to the action items in order to bring the total to one-hundred (100). As illustrated, however, the user is merely alerted that the total is not one-hundred (100). If it is determine in block 80 that the total is one-hundred (100), the method skips ahead to block 84. As indicated in block 84, the user is enabled to enter or edit whether the action item is public or private. If the user selects for an action item to be private, the action item will not be visible to other members. If public, at least a portion of the information regarding the action item is shared with other members of the group. In some embodiments, only the name of the action item is accessible by the group, while other embodiments also include rendering accessible one more of the other elements of the action item, i.e., frequency, amount, weighting, status of completion, etc. After block 84, the method returns to block 64 and the main GUI is updated and presented to the user.

If the user selects “auto-balance” from the main GUI (block 64), the method goes to block 88 (FIG. 4C), which indicates that a calculation is performed to determine the result of one-hundred (100) divided by the number of action items that have been entered for the user. The result is a percentage that may be applied to each action item to give them equal weights. According to block 90, the equal weights are assigned to each action item, where the weight for each is the percentage calculated in block 88. After the weights are assigned, the method returns to block 64, and the main GUI is updated and presented to the user.

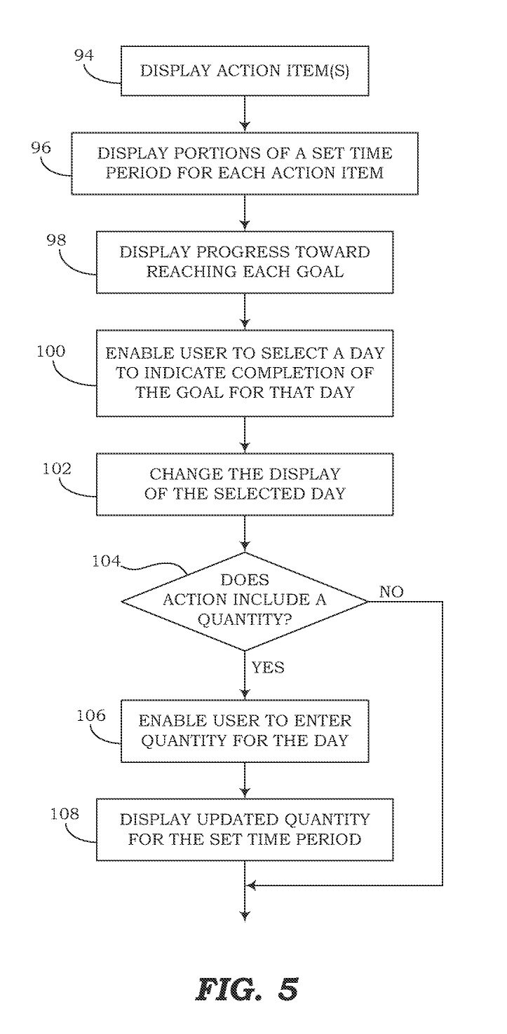

FIG. 5 is a flow diagram illustrating an embodiment of a method for displaying action items. In some embodiments, the flow diagram of FIG. 5 may represent various functions and functional results of the objective definition module 42 shown in FIG. 3. As indicated in block 94, the entered/defined action item(s) are displayed for the user. As indicated in block 96, discrete portions (e.g., days) of a set time period (e.g., one week) are displayed for each action item as selectable elements that, upon selection, subsequently indicate completion of at least a portion of an action item (progress) for that particular discrete portion of time (block 98). For example, the days Sunday, Monday, Tuesday, Wednesday, Thursday, Friday, and Saturday (or abbreviations of the days) are displayed near the label of the action item. For example, the days may be displayed in proximity to the respective action item label (e.g., beside, under, or over the respective action item label). Other embodiments include alternate time periods, including some embodiments in which the time period is selectable between different time periods, e.g., one week, two weeks, one month, one quarter, one year, etc.

As indicated in block 98, the progress toward completing each action item is displayed, based upon continuing input by the user throughout the set time period. For example, a user is enabled to click on day indicators (e.g., buttons, icons, etc.) in relation to each action item when at least a portion of an action item has been completed for a particular day. In addition, the user can enter an amount of a “throughout the week” action item that has been completed for a particular day. The progress may be displayed in any number of ways, such as by a number within a range (e.g., 86 out of 100), a grade (e.g., B+), in graphic form (e.g., bar graph, chart, table or other forms of graphical representation), and/or other manners of displaying progress. As indicated in block 100, the user is enabled to select a day to indicate completion of at least a portion of the action item for that day. For example, if the action item is to exercise four times per week, the user may select the day or days when he or she has exercised. As indicated in block 102, the display is changed in response to the user's selected days. For example, the display of the selected days may be changed in color, brightness, size, or in other visually distinctive ways. Additional progress changes are also reflected in some embodiments, e.g., “4 of 5” would be displayed if a user selects a 4th day to indicate completion of a portion of an action item on the 4th day out of a 5 day action item for that week.

Decision block 104 indicates that the method further includes determining whether the action item includes a quantity, such as for a “throughout the week” action item. If so, the method proceeds to block 106. In some embodiments, when the user selects a day in block 100, the user may be further enabled to enter a quantity for that day when the action item includes a quantity. This may be implemented by presenting a pop-up window next to the selected day to allow entry of the quantity. Block 106 indicates that the user is enabled to enter the quantity for that day. As indicated in block 108, an updated quantity of the amount and/or percentage of the action item completed up to that point is calculated and displayed. If it is determined in decision block 104 that the action item does not include a quantity, the method skips blocks 106 and 108.

The flow diagrams of FIGS. 4 and 5 show the architecture, functionality, and operation of possible implementations of the program for managing action items 30. In this regard, each block may represent a module, segment, portion of code, etc., which may comprise one or more executable instructions for performing the specified logical functions. It should be noted that the functions described with respect to the blocks may occur in a different order than shown. For example, two or more blocks may be executed substantially concurrently, in a reverse order, or in any other sequence depending on the particular functionality involved. Furthermore, one or more blocks are omitted in some embodiments.

The program for managing action items 30, which may comprise an ordered listing of executable instructions for implementing logical functions, may be configured, implemented, or embodied within any computer-readable medium for execution by any suitable processing or interpreting device. The computer-readable medium may be any medium that can store and/or transport programs for execution or interpretation by the processing device. Various examples of computer-readable media may include the media being written or read in an electronic, magnetic, electromagnetic, optical, infrared, and/or other manner. The computer-readable medium may include one or more suitable physical media components that can store the software, programs, or computer code for a measurable length of time.

FIGS. 6 through 8 illustrate embodiments of registration pages and login pages. FIG. 6 is an embodiment of a login page 112 having an email address field 114 and a password field 116. The login information entered into these fields may be saved on the end user device 14 when the user selects the “Remember Me” check box 118. The login page 112 further includes a sign-in button 120 that the user may select when information has been entered in the other fields. Of course, other embodiments include login pages that request different types of information to verify user identity, and some embodiments utilize alternative methods for such verification that do not include displaying pages to a user.

FIG. 7 is an embodiment of a page 124 allowing a user to create an account and sign-in. For enabling the user to create an account, the page 124 includes a name field 126, an email address field 128, a password field 130, and a confirm password field 132. The user may select the acceptance check box 134 when he or she reads and accepts the terms and conditions of the program for managing action items 30. The user may read the terms and conditions and privacy policy by clicking on a link 136.

When ready to submit, the user may press the sign up button 138. To complete registration, the user may select a sign up button 138.

After creating an account, the user may utilize the page 124 to sign in to the account to begin running the program. The sign in for the page 124 includes an email address field 140, a password field 142, and a “forgot?” link 144 (when the user forgets his or her password). To sign in, the user may select the sign in button 146.

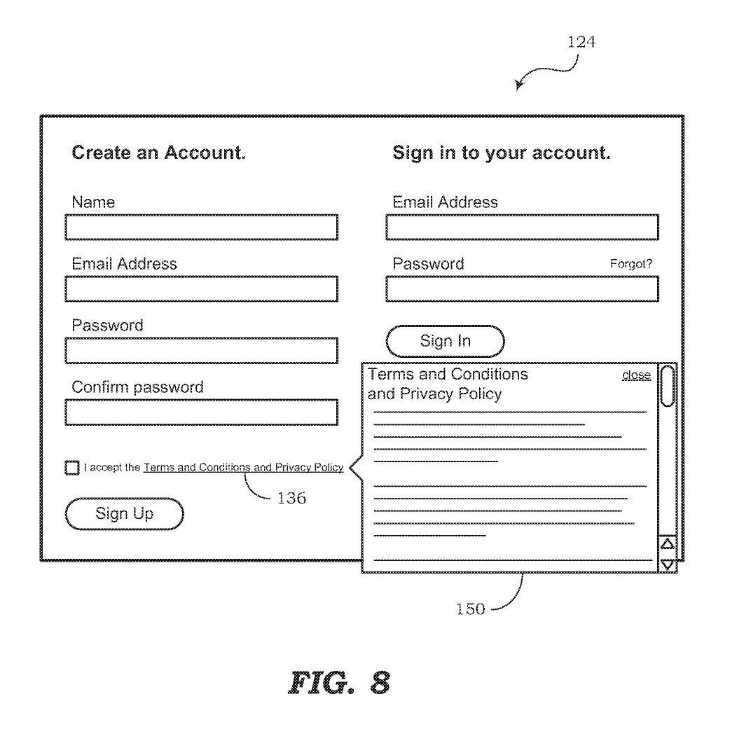

FIG. 8 shows the page 124 of FIG. 7 when the user clicks on the link 136. When the link 136 is selected, the page 124 displays a window 150 superimposed over some of the other elements of the page 124. The window 150 includes the Terms and Conditions and Privacy Policy for using the program for managing action items 30. Other methods of displaying terms and conditions may be used as well.

FIG. 9 is an embodiment of a user settings GUI 154 that enables a user to enter or edit personalized settings. The user settings GUI 154 includes a timezone field 156 to allow the user to select the timezone where the user is located. The user settings GUI 154 also includes a daily email check box 158 to allow the user to select whether or not he or she wishes to receive daily status emails. The user settings GUI 154 also includes a team email check box 160 to allow the user to select whether or not he or she wishes to receive team progress emails. Also, the user settings GUI 154 includes a notification check box 162 to allow the user to select whether or not he or she wishes to be notified by email when a message is received.

The user settings GUI 154 also includes a section for account information. This section includes a name field 164, a username field 166, a password field 168, and an email address field 170. These fields allow the user to enter and/or make changes to existing account information. To save the entries, the user may press a save button 172. The user settings GUI 154 further includes an image section to allow the user to upload an image (e.g., a profile photo). The uploaded image, if one exists, is displayed in window 174. To upload an image or to replace an existing image, the user may select the upload image button 176, which allows the user to browse saved images on the end user device 14. The new or replacement image is shown in the window 174. To allow an image to be removed, the user may click on the “remove” link 178.

FIG. 10 shows an embodiment of a dashboard GUI 182, which in some implementations may be referred to as the main GUI page. An initial version of the GUI 182 may be displayed for the user when the user first logs on. The GUI 182 displays an “Actions” section that enables the user to add and edit action items. An add/edit icon 183 is shown that when selected allows the user to add a new action item or edit an existing action item. In some embodiments, the add/edit icon 183 may be associated with the “add/edit action items” feature shown in FIG. 4A. The GUI 182 includes an instruction section 184 that describes how action items are to be entered. A label, or name, of a first action item may be entered into a first action item label field 186. A frequency, which represents how often or how many times during the course of the defined time period (e.g., one week) the user is expected to show a progress step toward completing the action item, is selected in a first frequency field 188. If the choice “throughout the week” (or throughout some other time period) is selected, in one implementation, there are no daily expectations of progress throughout the week, but expectations of a total amount for the entire time period. Furthermore, the GUI 182 is configured to display a quantity field 190, which allows the user to enter how much of the particular action item the user intends to complete. As shown in this example, the label of the first action item entered in the first action item label field 186 is “Read 500 pages.” Regarding this action item, the frequency is not defined by how many days the user intends to read, but the number of pages to be read throughout the week. Therefore, the number five-hundred (“500”) may be entered into the quantity field 190.

The GUI 182 further includes a first weight selector 192 that enables the user to select a percentage of the total of all action items that the user wishes to assign to the first action item, i.e., the weight of the action item. In this example, the user has given the first action item a weight of “30” (i.e., 30%). If one activity is more important to the user than another, the GUI 182 enables the user to assign more weight on the more important action items and less weight on the less important action items. The weight may be adjusted using a slider 194 of the first weight selector 192, and the selected weight is displayed near the first weight selector 192. The displayed number may be represented as a percentage of a total of all action item weights. Other embodiments include providing an input field into which the user is enabled to type in the desired numeric weight, with or without the slider 194. In some of those embodiments, a bar graph or other visual indicator shows the relative weights of each action item. By selecting or not selecting a private check box 196, the user may select whether the action item is to be kept private from others or to remain public to the other members of the team. The GUI 182 similarly displays a second action item label field 198, a frequency field 200, a second weight selector 202 and slider 204, and a private check box 206. In this example, the action item does not have a frequency of “throughout the week,” therefore causing the GUI 182 to avoid showing the quantity field (i.e., “how much?”) since it is not needed in this case. The GUI 182 is further configured to display the same format for other action items that the user wishes to enter.

The GUI 182 also includes a new action item link 208 that allows the user to enter a new action item. Also included is an auto-balance check box 210 that allows the user to select whether or not the weights of each action item are to be equal. Therefore, if the user wishes to put the same weight on each action item, the user may simply check the check box 210 instead of adjusting the weight selectors 192, 202, after which the user could also adjust the weights again, resulting in the auto-balance check box 210 becoming unchecked. In some embodiments, the auto-balance feature may be configured to override any changes made with the first weight selector 192, second weight selector 202, and/or other weight selectors for other action items. In other embodiments, this feature may allow the user to set certain weights individually and auto-balance the remaining weights. In yet other embodiments, auto-balancing will also provide a weight category selection, e.g., High, Medium, Low, with High weights being twice as much as Medium weights, which are twice as much as Low weights. When changes are made to the action items, the user may press the save button 212 to save the changes. To cancel the changes, the user may press the cancel button 214.

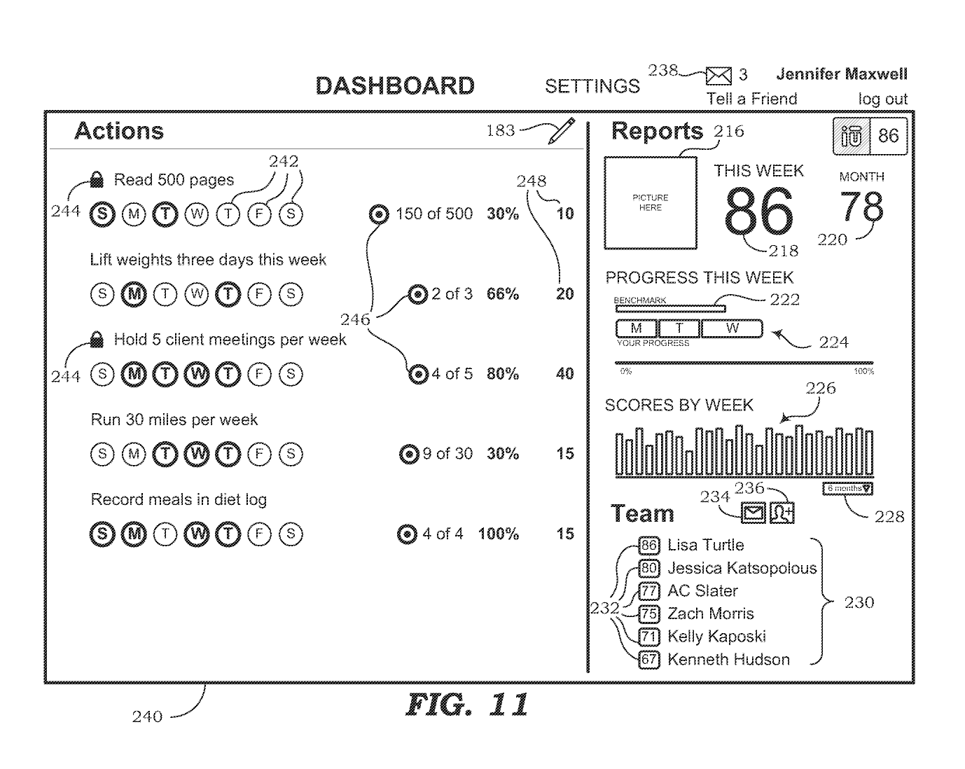

The GUI 182 also includes a Reports section and Team section, which are described in more detail with respect to FIG. 11. In FIG. 10, however, the scores are shown as “0” since the user has not yet had the opportunity to work toward reaching his or her action items. After this initial introduction page that allows the user to enter action items, additional GUIs may be displayed as described below.

FIG. 11 illustrates one example of an embodiment of a GUI 240 for displaying the action items which have been set and for enabling a user to enter updates to record progress. Reports and Team sections represent progress over the past six months and show that the user is part of a team having six other members. In this example, an “Actions” section lists five action items that have been entered, including “Read 500 pages,” “Lift weights three days this week,” “Hold 5 client meetings per week,” “Run 30 miles per week,” and “Record meals in a diet log.” Below each action item label are buttons 242 that designate each day in the time period (e.g., week). When the user clicks on a button 242 for one of the days, the button 242 is displayed in a distinctive manner. For example, when selected, the GUI 240 may change the appearance of the selected day by highlighting the day (e.g., by converting the lines or font to bold, increasing the size, changing the color, etc.). In one embodiment, changes to the current score are calculated and displayed by the end user device 14 before communication to the server 12 (FIG. 1) to reduce latency. In such an embodiment, score calculation and display functionality are initially downloaded to the user device 14 along with the page shown as GUI 240 (or previously stored as part of a user application on a handheld device, for example).

When an action item is designated as private (e.g., by checking the appropriate box 196, 206, etc., in the GUI 182 of FIG. 10), a lock symbol 244 is displayed next to that action item. An action item progress section 246 is shown for each action item and indicates how much progress has been made toward completion of that action item. For example, FIG. 11 indicates that the example user has lifted weights twice so far in the week, amounting to 66% of the 3 times necessary to complete the action item. Also, the weights 248 for each action item are displayed.

The GUI 240 further comprises a Reports section, which shows the progress toward completing the action items in a number of ways. In the example shown in FIG. 11, it is assumed that the user has been using the system for many weeks, is currently in the middle of a week, and is viewing the edit screen (however changes made during a week would preferably not take place until a following week in order to maintain scoring consistency for the benefit of other users). An image window 216 shows a photo or other image for the user. The GUI 240 also includes a user score 218 corresponding to the current progress in the current (first) time period. In this example, the score “86” is given for the week. Also, a second score 220 is displayed for a longer (second) time period, where, in this example, a score of “78” is given for the time period of a month prior to the present day. In other embodiments, the second time period corresponds to an average of the four previous final weekly scores for the user.

Also, a portion of the Reports section shows the progress for the current time period (e.g., week) in a chart to be compared with a benchmark bar 222, which graphically shows how much time has elapsed since the beginning of the week. A user aggregate progress bar 224 is shown next to the benchmark 222, where the size of each part of the aggregate progress bar 224 that is assigned each day represents the amount of progress that was made for that particular day. By comparing the aggregate progress bar 224 to the benchmark 222, a user is able to determine whether or not he or she is falling behind the expectations for the week. A “Scores by Week” section is included in the Reports section as well. In some embodiments, the time period may be a period other than a week, such as a bi-week, a month, etc. A bar graph 226 shows the results for each of the past weeks. The pull-down 228 allows the user to select the length of time over which the results of past weeks are displayed. In this example, the results from the past six months (i.e., 26 weeks) are displayed.

The GUI 240 also includes a Team section for displaying aspects of one or more teams that the user has joined. In some embodiments, selections may be provided for allowing the user to select which team or teams are displayed. In FIG. 10, the members 230 of one team are listed, and the scores 232 for each person are displayed next to each team member name. As illustrated, the members may be listed in a manner such that the person with the highest score is at the top of the list and the person with the lowest score is at the bottom. According to some embodiments, the members of a user's team may or may not be members of each other's teams. Thus, a user may join with other people who are known to the user. An email icon 234 may be selected to allow the user to send an email (or other type of message) to one or more of the team members. If the user wishes to add another person to the team, the user may select the add button 236. Another embodiment includes the picture, current score and 4-week average score in a top section, team member names and score in a middle section, and benchmark bar 22 and aggregate progress bar 224 below the middle section, and the “Scores by Week” section at the bottom of the display.

The GUI 240 further comprises a message count icon 238 that is configured to display that the user has messages from other team members that have not yet been read. In this example, a number “3” is shown to indicate that there are three unread messages. By selecting the message count icon 238, the user is able to navigate to a message page to view the messages.

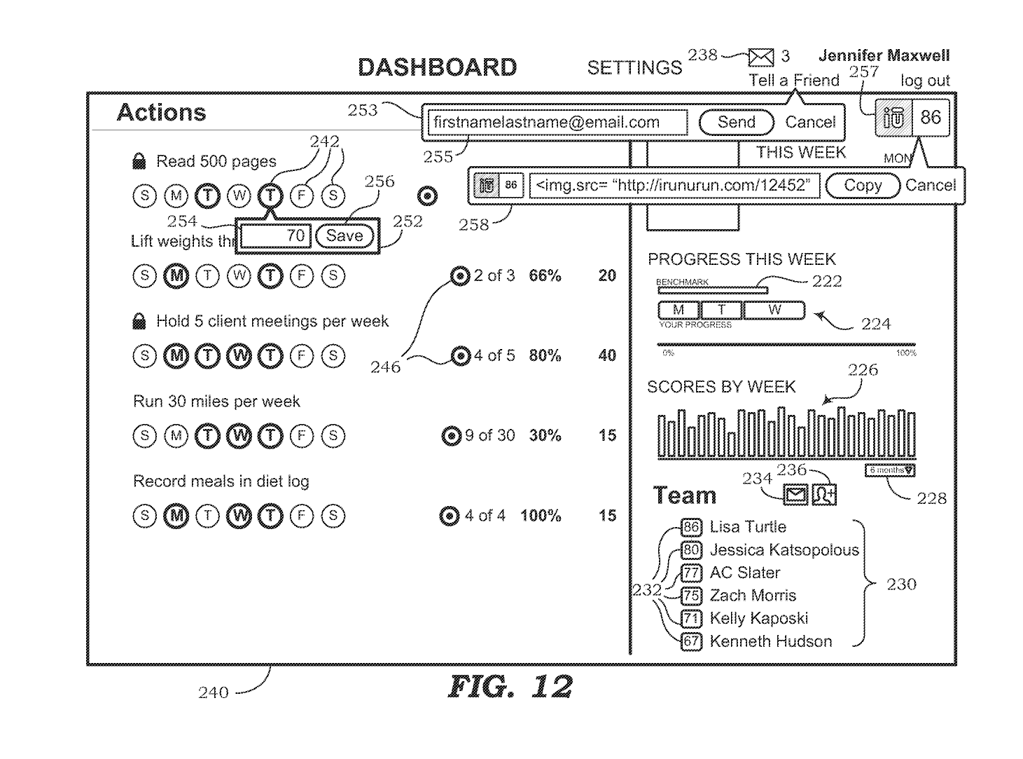

FIG. 12 shows the GUI 240 of FIG. 11 when various icons are selected. In the Actions section, a day is selected to enter progress toward completing an action item having a quantity. For example, two action items in the set involve quantity, namely “Read 500 pages” and “Run 30 miles per week.” When a day button 242 of a particular action item is selected, a window 252 is displayed to enable the user to enter an amount to be added to the cumulative total. A number may be typed into a quantity field 254, and a save button 256 may then be pressed. The system may then calculate the new totals.

In addition, FIG. 12 illustrates how the GUI 240 is displayed when a “Tell a Friend” icon is selected. In this case, a window 253 is displayed that includes an address field 255 in which the user may enter the e-mail address of a person who the user wishes to notify. The window 253 also includes a send button and a cancel button to allow the user to send the notification or to cancel it. The window 253 may also include text for describing the function of the window, such as “Share your score on the web.” The example of FIG. 12 also shows the result of the user selecting a logo/score icon 257. The logo/score icon 257 includes a logo for the product and one of the user's scores, which, in this case, is the score for the first time period (e.g., current week). When the logo/score icon 257 is selected, a window 258 is displayed that includes a logo/score snippet with the user's score contained therein. Also, the window 258 may show source code or hyperlink to the image source, and copy and cancel buttons. The image of the logo/score snippet may be copied, if the user desires, and placed in a blog, web page, or other resource. The window 258 may also include text for describing its function, such as “Share your score with others by pasting this snippet into your blog or web page.”

FIG. 13 is a diagram of a GUI 260 for use by an administrator of an enterprise. In this example, the hypothetical name of the enterprise is “Company XYZ.” The GUI 260 enables the administrator to add a user using a first user add button 262 and/or add a team using a first team add button 264. In this example, several individuals and teams are displayed. A “Marketing” team is shown with a few employees directly in that team. To add a user to the Marketing team, the administrator may select a second user add button 266 and/or, to add a sub-team nested under the Marketing team umbrella, the administrator may select a second team add button 268. In this example, other sub-teams under the Marketing team include a “Direct” team, an “Advertising” team, and a “Sales” team. When a team or sub-team is selected, add user buttons and add team buttons are presented to allow the administrator to expand as needed.

When the employee “John Doe” in the Marketing team is selected, the right side of the GUI 260 displays the details of John Doe's information. By clicking on the admin box 270, the administrator may designate “John Doe” as another administrator. Also, if this person is to be excluded from the normal team action items, then the user may select the exclusion box 272. In addition, the action items for this employee may be viewed and/or edited as needed and new action items may be added. Similar controls for entering and editing action items are provided to the administrator as those given to the individual with respect to the fields described with regard to FIG. 10.

FIG. 14 illustrates an embodiment of a Settings GUI 276 for an enterprise. The GUI 276 allows the administrator to enter selections (e.g., timezone, email requests, etc.), account information (e.g., name, username, password, email address, etc.), and image data for the user similar to the Settings GUI 154 of FIG. 9. In addition, the Settings GUI 276 also includes a Custom Logo and Colors section. In this section, the administrator may select a logo to be displayed for all users of the enterprise using an upload logo button 278. The administrator may be prompted to browse through files on the administrator's computer to upload the logo.

GUI 276 also displays samples of colors for each of the different reports. For example, the report for representing the progress by a total score includes a first color sample 280 having a first color number 282 (i.e., ff6600), which is an RBG number in hexadecimal form that represents the color shown in the first color sample 280. A score appearance sample 284 is shown. Also, a second color sample 286 is displayed having a second color number 288. A progress appearance sample 290 is shown with the selected color. Further, a third color sample 292 is shown having a third color number 294 and a results appearance sample 296 is displayed. If the administrator wishes to modify the color schemes, such as to match colors with those colors used in the enterprise's logo or in some other way associated with the enterprise, the administrator may click on one of the color samples 280, 286, 292.

FIG. 15 illustrates the GUI 276 of FIG. 14 when the second color sample 286 has been selected for modification. The GUI 276 displays a modification window 300 superimposed over other elements. The modification window 300 includes a color palette 302, a brightness bar 304, and a color number window 306 for entering a desired color and brightness. When the desired color is selected, the administrator may press the OK button 308 to assign the selected color for that Report category (i.e., the “Progress This Week” report).

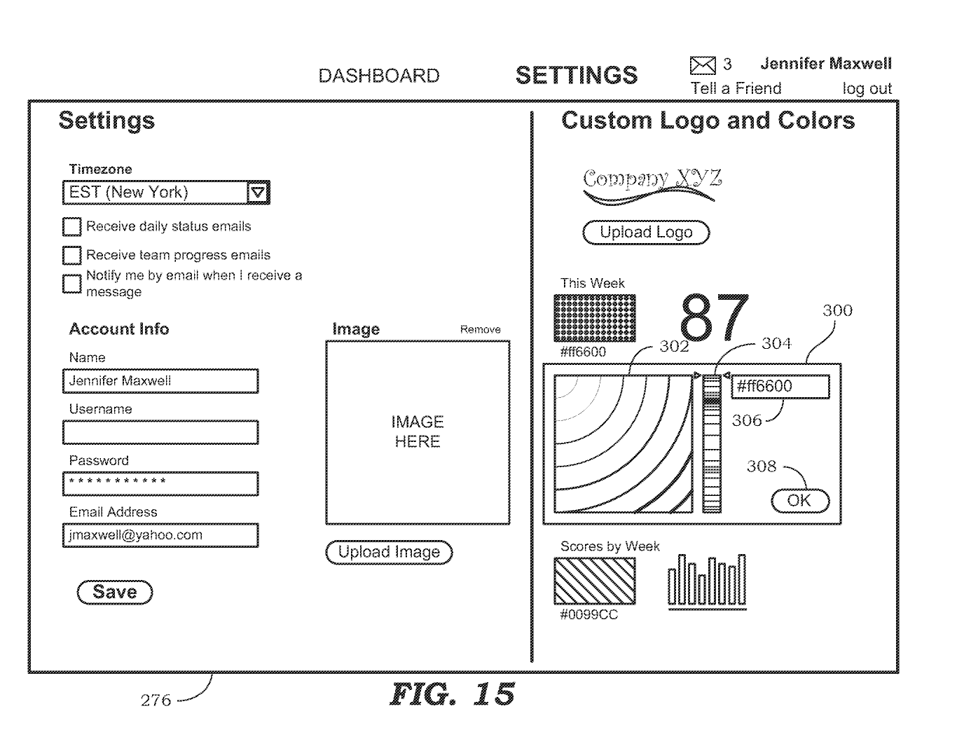

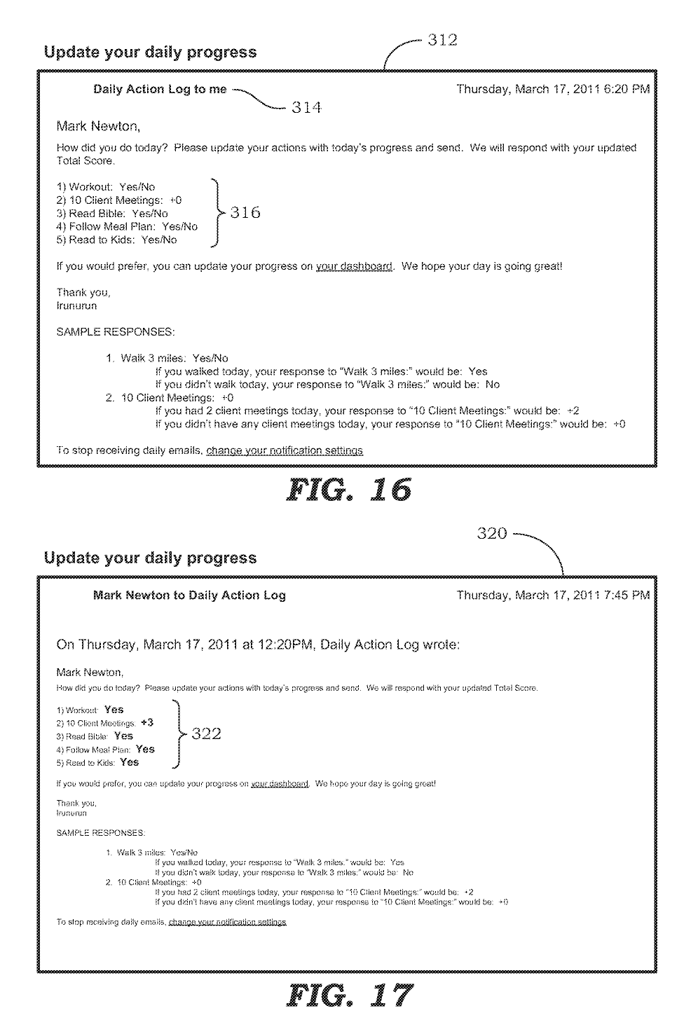

FIG. 16 is an example of an email update message 312 according to various embodiments. The email update message 312 in this embodiment is sent to the user for the purpose of allowing the user to update his or her daily progress. The message is sent from a “Daily Action Log” to the user, as indicated in line 314. After a brief introduction, the email update message 312 includes a list 316 of the action items for the user, each action item followed by an appropriate response. For example, a response to some action items may be either “yes” or “no.” However, if a quantity is to be entered, the response may be a plus sign followed by a number (e.g., “+50”).

FIG. 17 is an example of a response message 320 that the user may create for responding back to the “Daily Action Log” address. The response message 320 may include the text of the original message (i.e., the email update message 312) with updates 322 to the progress of each of the action items. For the yes/no action items, the user enters “yes” or “no” to indicate whether or not the user has performed that action item for the day. For example, if an action item is “work out three times per week,” a “yes” response indicates that the user worked out that day. For quantitative action items, the user enters “+” followed by a number representing the quantity achieved that day. For example, with an action item “conduct 10 client meetings,” if the user conducts three meeting that day, the user may enter “+3.”

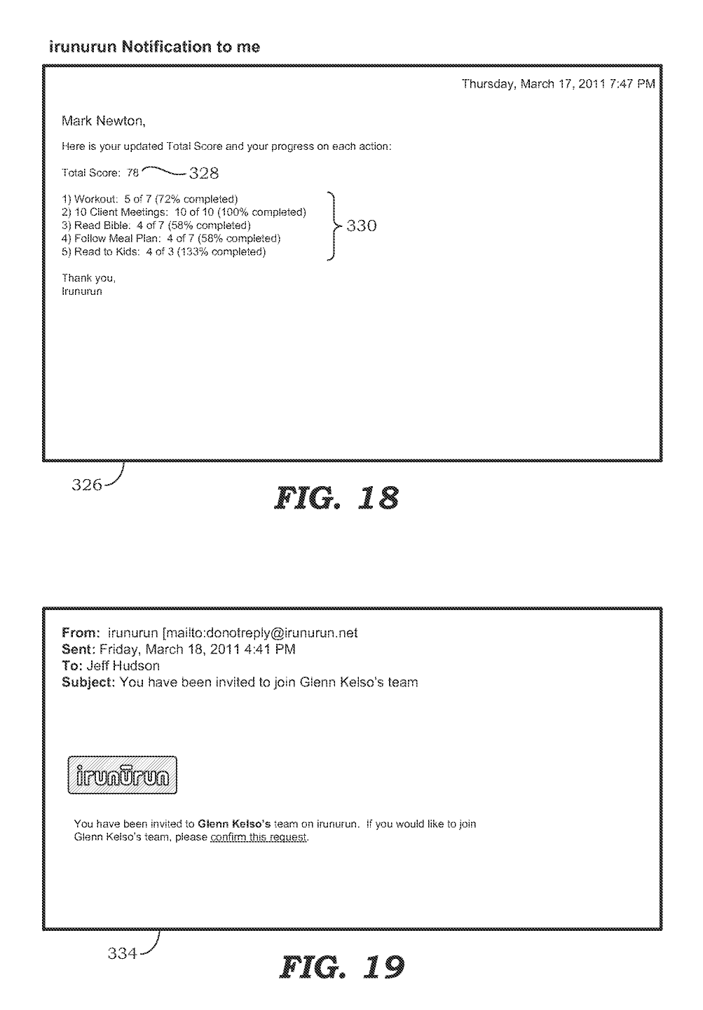

FIG. 18 is an example of a notification message 326 sent to the user after receiving the response message 320. The program for managing action items 30 calculates the progress for the time period (e.g., one week) and includes the total score 328 (e.g., “78” in this example) and portions and/or percentages 330 of completion of the action items for the time period. The notification message 326 is intended to keep the user up to date on a daily basis in order to help the user stay focused. In some embodiments, FIGS. 16-18 can also include names and scores of top performing members of a team, while other embodiments include names and scores of all team members.

FIG. 19 is an example of an invitation message 334 sent from a user to a friend. A user may wish to invite others to join his or her team in order to create an accountability group with the other people. To invite someone, the user may select the “Tell a Friend” icon as described above with respect to FIG. 12 (or using other means for creating a new message). The invitation message 334 may include a hyperlink, such as a “confirm this request” link for the invitee to select if he or she wishes to join the team.

It should be emphasized that the above-described embodiments are merely examples of possible implementations. Many variations and modifications may be made to the above-described embodiments without departing from the principles of the present disclosure. All such modifications and variations are intended to be included herein within the spirit and scope of the present disclosure and protected by the following claims.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

I/We claim:

1. A server in communication with a network, the server comprising:
a processing device configured to execute logic instructions of the server;
an objective definition module configured to enable a user of the end user device to define at least one action item intended to be performed by the user during a specific time period; and
a recordation module configured to receive updates from the user regarding a successful completion of at least a portion of the at least one action item.

2. The server of claim 1, wherein the recordation module is further configured to calculate progress that the user has made in performing each of the at least one action items, wherein the progress is calculated as a weighted score, with each action item having a designated weight.

3. The server of claim 2, wherein the recordation module is further configured to send a report of the calculated progress to the end user device via an email message.

4. The server of claim 2, wherein the recordation module is further configured to display the progress on a web page accessible by the user.

5. The server of claim 1, further comprising a database management module configured to control a database for storing an email address and password for the user, the at least one action item for the user, and the progress of the user in performing the at least one action item.

6. The server of claim 5, the database management module further configured to control a database for storing results from at least one previous time period.

7. The server of claim 1, further comprising an email module configured to send an email to the user to prompt the user to provide updates regarding the successful completion of at least a portion of the at least one action item.

8. The server of claim 1, further comprising a team management module configured to enable the user to invite other users to join a team and further configured to enable the user, when invited, to join other teams if desired.

9. The server of claim 8, wherein, for each of the at least one action item, the objective definition module is further configured to enable the user to enter whether the respective action item is accessible by other members of a team.

10. The server of claim 8, wherein the user is measured in comparison to the performance of each of the other users in the team through the calculation of progress scores representing weighted percentages of completions of all action items within a specific time period.

11. The server of claim 1, wherein, for each of the at least one action item, the objective definition module is further configured to enable the user to enter how many times the user intends to perform steps toward completing the respective action item during the specific time period

12. The server of claim 1, wherein, for each of the at least one action item, the objective definition module is further configured to enable the user to enter how much of the respective action item the user intends to perform during the specific time period.

13. A computer-implemented method comprising:
displaying at least one action item to be performed by a person;
displaying, with each at least one action item, a representation of days within a specific time period during which the person is intended to perform the at least one action item;
enabling the person to select a specific day associated with a first action item to indicate completion of a portion of the first action item for the specific day; and
changing the appearance of the representation of the specific day.

14. The computer-implemented method of claim 13, further comprising:
determining whether the first action item associated with the selected specific day includes a quantity; and
if the first action item includes a quantity, enabling the person to enter an amount of the first action item the person accomplished during the selected specific day.

15. The computer-implemented method of claim 13, further comprising:
displaying the progress that the person has made toward performing each at least one action item during the specific time period.

16. The computer-implemented method of claim 15, further comprising:
displaying a total score based on at least the progress that the person has made toward reaching each of the at least one action item and a weighting factor for each of the at least one action item.

17. The computer-implemented method of claim 16, further comprising:
displaying a chart representing the total scores for a plurality of previous time periods.

18. The computer-implemented method of claim 13, wherein the person is a member of an enterprise having at least one administrator, the computer-implemented method further comprising:
enabling the at least one administrator to perform at least one of adding and editing the at least one action item for the person.

19. The computer-implemented method of claim 18, further comprising:
enabling the at least one administrator to customize settings of at least one graphical user interface for members of the enterprise.

20. The computer-implemented method of claim 13, further comprising enabling the user to join a team of other users with similar action items.

21. The computer-implemented method of claim 20, further comprising enabling comparison of the user to other members of the team.

22. A computer-readable medium having instructions stored thereon, the instruction being executable by a processing device, the computer-readable medium comprising:
logic adapted to enable a user to enter a first action item into a first input field, the first action item being set to provide a benchmark for a person to perform during a specific time period;
logic adapted to enable the user to enter into a second input field a frequency of the action item to be performed by the person during the specific time period;
logic adapted to determine if the frequency of the action item is throughout the specific time period and, if so, to enable the user to enter into a third input field a quantity of the action item to be performed by the person during the specific time period to perform the first action item; and
logic adapted to display the first action item, frequency, and, if entered, the quantity.

23. The computer-readable medium of claim 22, wherein
the logic adapted to enable the user to enter the first action item further enables the user to enter at least one additional action item,
the logic adapted to enable the user to enter the frequency further enables the user to enter a frequency for each of at least additional action item, and
the logic adapted to enable the user to enter the quantity further enables the user to enter a quantity for each of the at least one additional action item when the frequency for the respective at least one additional action item is throughout the specific time period.

24. The computer-readable medium of claim 23, further comprising logic adapted to enable the user to enter a weight for at least one of the first action item and the at least one additional action item.

25. The computer-readable medium of claim 24, further comprising logic adapted to alert the user when the total of the weights does not equal 100.

26. The computer-readable medium of claim 23, further comprising logic adapted to automatically weight each of the first action item and the at least one additional action item evenly.

27. The computer-readable medium of claim 22, wherein the user and the person are the same.

28. The computer-readable medium of claim 22, wherein the user is an administrator of an enterprise and the person is one of a number of members of the enterprise.

29. The computer-readable medium of claim 28, further comprising logic adapted to enable the user to enter whether the first action item is to be private and inaccessible by other members of the enterprise.

30. The computer-readable medium of claim 22, wherein the specific time period is one week.
